(19) United States
(12) Patent Application Publication
(10) Pub. No.: US 2010/0294168 A1
(43) Pub. Date: Nov. 25, 2010

(54) Transparent Coatings

(75) Inventors: Qi Sun, Kanagawa-ken (JP); Daniel Ray Fruge, Wilimington, DE (US); Demetrius Michos, Clarksville, MD (US)

Correspondence Address: William D Bunch;W R GRACE & CO-Conn, Patent Department, 7500 Grace Drive, Columbia, MD, 21044-4098, US

(73) Assignee: W. R. GRACE & CO.-CONN., Columbia, MD (US)

(21) Appl. No.: 12/225,282

(22) PCT Filed: Mar. 22, 2007
(86) PCT No.: PCT/US2007/007122

§ 371 Date: Aug. 12, 2010

Related U.S. Application Data
(60) Provisional application No. 60/784,816, filed on Mar. 22, 2006.

(51) Int. Cl. C09D 1/00

(52) U.S. Cl. 106/287.34

(57) ABSTRACT

An inorganic oxide coating produced by preparing a coating composition comprising inorganic oxide particles and a polymer, applying the composition on a substrate to form a coating, and heating the substrate to remove the polymeric component, wherein the resulting coating is transparent.

### BACKGROUND OF THE INVENTION

This invention relates to non-aggregated inorganic oxide particulate coatings, and dispersions used to make such coatings. The invention also relates to methods of making the coatings.

Hardenable coatings containing inorganic particulates are well known. Such coatings include film forming polymers and other organic components. The film formulated by applying an aqueous dispersion of inorganic oxide and polymeric components, followed by curing of the film. See, for example U.S. Pat. Nos. 4,330,446 and 4,016,129.

These hardenable coatings are typically utilized for protection of various substrates such as metal, glass, wood, etc. U.S. Pat. No. 6,210,750 describes the use of colloid silica and siloxane polymer to form a transparent hard coating on glass substrates.

U.S. Pat. No. 3,013,897 describes an aggregated colloidal silica particulate coating for metal substrates wherein the particulate is combined with a film forming polymer and subsequently the coating is dried and the polymer is removed by heating. The coating is suitable for use as protective metal coatings but is not transparent.

Various inorganic oxide non-particulate coatings have been utilized as dielectric layers for microelectronic applications. For example, Japanese Patent No. H03-37933 describes the use of low-temperature softening glass on dielectric layers for certain microelectronic display devises. However, such coatings possess low light transmittance.

Other non-particulate inorganic oxide coatings utilized as dielectric coatings have been prepared by chemical vapor deposition (CVD). See, for example, Chemical Vapor Deposition for Microelectronics by Arthur Sherman, Noyes Publications, Park Ridge, N.J. (1987). These CVD coatings possess good transparency and insulating properties, and are crack-free, but are extremely expensive to manufacture.

Accordingly there is a need for transparent dielectric coatings that possess good transmittance and insulating properties, and are crack-free, but also are less expensive to manufacture.

### SUMMARY OF THE INVENTION

The present invention relates to an inorganic oxide coating produced by preparing a coating composition comprising inorganic oxide particles and a polymer, applying the composition on a substrate to form a coating, and heating the substrate to remove the polymeric component, wherein the coating is transparent.

In another embodiment of the present invention, the inorganic oxide coating is non-aggregated, transparent, and/or electrically insulating. As defined herein “non-aggregated” means that the inorganic oxide particles are essentially unchanged in size and have not grown by merging particle masses.

A further embodiment of the present invention relates to a flat panel display device including an inorganic oxide coating produced by preparing a coating composition comprising inorganic oxide particles and a polymer, applying the Composition on the display to form a coating, and heating the display to remove the polymeric component, wherein the coating is transparent.

### DETAILED DESCRIPTION OF THE INVENTION

The instant invention pertains to transparent inorganic oxide films that are inexpensive and easily manufactured, while still providing excellent electrical insulating properties, toughness, coherency, and substrate adhesion.

The present invention relates to an inorganic oxide coating produced by preparing a coating composition including inorganic oxide particles and a polymer, applying the composition on a substrate to form a coating, and heating the substrate to remove the polymeric component, wherein the coating is transparent.

In another embodiment of the present invention, the inorganic oxide coating is non-aggregated, transparent, and/or electrically insulating.

A further embodiment of the present invention relates to a flat panel display device including an inorganic oxide coating produced by preparing a coating composition including inorganic oxide particles and a polymer, applying the composition on the display to form a coating, and heating the display to remove the polymeric component, wherein the coating is transparent.

The inorganic oxide may include silica, alumina, titania, zirconia, etc., and may be in various forms (e.g., amorphous or crystalline) or made by different processes including fumed, precipitated, colloidal, gel, etc.

Typically, the inorganic oxide may be silica. The silica is preferably amorphous and more preferably it is colloidal silica, even though other inorganic oxides in different forms, as mentioned herein, may perform equally with regard to this invention.

The inorganic oxide particles may be used in the form of a dispersion in an aqueous system, the individual discrete particles in this dispersion being in the average size range of from 2 to 150 nanometers, preferably between 5 and 80 nm and more preferably between 10 and 40 nm, depending on the desired effects in the resulting coating. For example, the dispersion may contain monodisperse particles, or mixtures of two different monodisperse particles; polydisperse particles, or mixtures of two different polydisperse particles; or mixtures of different monodispere and polydisperse particles. Processes for producing such finely divided inorganic oxide particles are well known. A general description of these processes is given, for example, in Chapters 2 and 3 of Small Particles Technology, by Jan-Erik Otterstedt and Dale A. Brandreth, Plenum Press, New York, 1998, the contents of which are incorporated herein by reference.

Inorganic oxide particles typically may be of the non-reticulated or non-aggregated type, and if any aggregation is present, it should be so loose that the aggregated particles are readily broken down by milling. Dispersions or sols in which the particles have a strong tendency to aggregate, gel quite readily, and it is preferred in the present invention to use sols which can be concentrated at least to 20% by weight of inorganic oxide without gelling or solidifying.

In the embodiment where the inorganic oxide is colloidal silica, dispersions or sols may be prepared according to a variety of processes, such as that shown in U.S. Pat. No. 2,892,797, the contents of which are incorporated herein by reference. The sols of this patent have uniform, discrete, spherical particles up to 150 nanometers in average diameter. By the term “colloidal silica” or “colloidal silica sol” it is meant particles originating from dispersions or sols in which the particles do not settle from dispersion over relatively long periods of time. Such particles are typically below one micron in size. Similarly suitable are the sols of U.S. Pat. Nos. 2,244,325; 2,574,902; 2,577,484; 2,577,485; 2,631,134; 2,750,345; 2,892,797; 3,012,972; and 3,440,174, the contents of which are incorporated herein by reference. These sols are composed of discrete silica particles in the diameter range of about 1 to 300 nanometers. Typically, the silica possesses a monodisperse particle size distribution in which the average particle size ranges from 2 to 150 nanometers. Colloidal silicas can have a surface area (as measured by BET) in the range of 9 to about 2700 m²/g.

Colloidal silica particularly suitable for this invention is what is known as polydisperse colloidal silica. “Polydisperse” is defined herein as meaning a dispersion of particles having a particle size distribution in which the median particle size is in the range of 15-100 nm and which has a relatively large distribution span. Preferred distributions are such that 80% of the particles span a size range of at least 30 nanometers and can span up to 70 nanometers. The 80% range is measured by subtracting the d₁₀ particle size from the d₉₀ particle size generated using TEM-based particle size measurement methodologies described later below. This range is also referred to as the “80% span.” One embodiment of polydisperse particles has particle size distributions that are skewed to sizes smaller than the median particle size. As a result, the distribution has a peak in that area of the distribution and a “tail” of particle sizes that are larger than the median. A particularly suitable polydisperse silica has a median particle size in the range of 20 to 30 nanometers and 80% of the particles are between 10 and 50 nanometers in size, i.e., 80% of the distribution has a span of 40 nanometers.

Monodisperse colloidal silica may also be used. “Monodisperse” is defined herein as meaning a dispersion having a particle size distribution in which the average particle size is in the range of 5-150 nm and which has a relatively small distribution span. Many monodisperse colloidal silicas have Gaussian particle size distributions, so standard deviation may be used as a measure of particle size dispersion. Monodisperse colloidal silicas of use in this invention have an average particle size, as measured by TEM, between 2 and 150 nm, preferably between 5 and 80 nm and more preferably between 10 and 40 nm, depending on the desired effects in the resulting coating. Standard deviations as measured by TEM are typically 10-30% of the average particle size.

Most colloidal silica sols contain an alkali. The alkali is usually an alkali metal hydroxide from Group IA of the Periodic Table (hydroxides of lithium, sodium, potassium, etc.) Most commercially available colloidal silica sols contain sodium hydroxide, which originates, at least partially, from the sodium silicate used to make the colloidal silica, although sodium hydroxide may also be added to stabilize the sol against gelation.

Generally speaking, colloidal silica possesses a net negative charge and therefore is anionic as a result of the loss of protons from silanol groups present on the silica's surface. The colloidal silica particles that are surface modified with aluminate according to, e.g., U.S. Pat. No. 2,892,797 (the contents of which are incorporated herein by reference) are also anionic and may be used in this invention.

For the purposes of this invention, colloidal silica is considered cationic if the anionic colloidal silica particles have been physically coated or chemically treated so that the colloidal silica possesses a net positive charge. A cationic silica thus would include those colloidal silicas in which the surface of the silica contains a sufficient number of cationic functional groups, e.g., a metal ion such as aluminum, or an ammonium cation, such that the net charge is positive.

Several types of cationic colloidal silica are known. Such cationic colloidal silicas are described in U.S. Pat. No. 3,007,878, the contents of which are incorporated by reference. Briefly, a dense colloidal silica sol is stabilized and then coated by contacting the sol with the basic salt of a trivalent or tetravalent metal. The trivalent metal can be aluminum, chromium, gallium, indium, or thallium, and the tetravalent metal can be titanium, germanium, zirconium, stannic tin, cerium, hafnium, and thorium. Aluminum is preferred. The anions in the polyvalent metal salt, other than hydroxyl ions, are so selected as to make the salt soluble in water. It will be understood that when reference is made herein to the fact that the salt has a monovalent anion other than hydroxyl, the intention is not to exclude hydroxyl from the salt but to indicate that another anion is present in addition to the hydroxyl which the salt contains. Thus all basic salts are included, provided they are water-soluble and can produce the required ionic relationships as hereinafter described.

Colloidal sols of positively charged silica may be prepared by depositing aluminum on the surface of colloidal silica particles. This may be achieved by treating an aquasol of negatively charged silica with basic aluminum salts such as basic aluminum acetate or basic aluminum. Processes for preparing these positively charged silica sols are disclosed in U.S. Pat. No. 6,902,780, U.S. Pat. No. 3,620,978; U.S. Pat. No. 3,956,171; U.S. Pat. No. 3,719,607; U.S. Pat. No. 3,745,126; and U.S. Pat. No. 4,217,240, all of which are incorporated herein by reference. The aluminum treatment results in aluminum:silica ratios at the surface of the colloidal particles ranging from about 1:19 to about 4:1. Preferred for use herein are aluminum:surface silica ratios of from about 1:2 to about 2:1.

In another embodiment, the inorganic oxide is colloidal silica and is preferably prepared by treating the surface of the inorganic oxide with an organic compound having a functional group with a positive charge and also having at least one group, which is reactive with silanol groups on the surface of the inorganic oxide. Preferably, the group that is reactive with the silanol group is a silane and positive functional groups include, but are not limited to, amino groups or quaternary groups such as described in U.S. Pat. No. 6,896,942, the contents of which are incorporated herein by reference.

Typically, the inorganic oxide dispersion or sol of the present invention contains only small amounts of sodium hydroxide or other hydroxide stabilizing agents. Stability of the sol may be achieved by deionizing the particles to remove all but trace quantities of alkaline ions from the sol. Alkali metal ions may be replaced by H+ ions to achieve an operating pH range of 2.5-7.0. Known methods of deionization which may be used include, but are not limited to, the use of ion exchange resins and dialysis. Such process is described in U.S. Pat. No. 2,892,797. The low alkali cationic colloidal silicas can be prepared by deionizing them to an extent such that the colloidal silica has a silica solids to alkali metal ratio referred to in Equation 1. By “deionized,” it is meant that any metal ions, e.g., alkali metal ions such as sodium, have been removed from the colloidal silica solution. Methods to remove alkali metal ions are well known and include ion exchange with a suitable ion exchange resin (U.S. Pat. Nos. 2,577,484 and 2,577,485), dialysis (U.S. Pat. No. 2,773,028) and electrodialysis (U.S. Pat. No. 3,969,266), the contents of which are incorporated herein by reference.

As indicated above, the colloidal silica sols of this invention have relatively low levels of alkali metal ions, which are necessary to achieve a largely unaggregated inorganic coating with high transparency and high electrical insulating characteristics. Maximum alkali metal level in the colloidal silica sol may be calculated from the equation below:

SiO₂/Alkali Metal≧AW(−0.013*SSA+9) Equation 1

The SiO₂/Alkali Metal is the weight ratio of silica solids and alkali metal in the colloidal silica sol. AW is the atomic weight of the alkali metal, e.g., 6.9 for lithium, 23 for sodium, and 39 for potassium, and SSA is the specific surface area of the colloidal silica particles in units of square meters per gram (m²/g). When the alkali metal is sodium, the SiO₂/Alkali Metal ratio is at least the sum of −0.30SSA+207.

In one embodiment of this invention the inorganic oxide comprises a stabilizing agent for colloidal silica. Ammonia may be utilized as the stabilizing agent. Ammonia-containing colloidal silica and methods for making the same are known in the art such as described in Ralph K. Iler's The Chemistry of Silica, John Wiley & Sons, New York (1979) pages 337-338, the contents of which are incorporated herein by reference. Briefly, a sodium containing colloidal silica is prepared using conventional conditions. The sodium ions are then exchanged with ammonium ions using a suitable cation exchange resin, many of which are readily available. Typically, the ammonia containing embodiments contain at least 0.01 weight %, and preferably 0.05 to 0.20% by weight ammonia wherein ammonia content is measured by conventional acid/base titration. Certain commercially available colloidal silicas containing ammonia have suitable silica solids to alkali ratios and would be suitable as is. Other embodiments may be prepared by deionizing colloidal silica having higher alkali content and subsequently adding ammonia.

As mentioned herein, it is an object of the invention to prepare thick (e.g., above 2 microns) oxide films. Since silica will be the only remaining component of the formulation after drying and firing the coated film, the silica concentration in the formulation should be as high as possible. The concentration of the silica in the coating composition, as it is applied to the substrate, may be in the range of about 1 to about 50%, and typically is in the range of about 5 to about 40%, and more typically in the range of about 10 to about 30% by weight of the composition.

Colloidal silica particles alone do not provide thick films because capillary stress during drying results in crazing such that the film usually breaks up into powder. The polymer performs two main functions: it reduces crazing and particle aggregation so that the film remains coherent and transparent after it has been dried.

The polymer employed in a composition of this invention may be dispersed in the medium in which the silica is dispersed. Thus, if water is the continuous phase of the silica, the polymer should be water dispersible, at least in part. If the polymer is water soluble, or colloidally dispersible it is, of course, water dispersible.

The polymer may be heat removable from the composition after it is coated on the substrate. It can be either volatilized or removed by combustion or decomposition such that it leaves very little or essentially no residue in the coating. The temperature utilized during this process should be high enough to effect this removal but not so high as to create deformity, cracking or melting of the substrate. For many substrates, temperatures in the range 200° C. to 700° C. are appropriate and polymers that depolymerize cleanly and readily in this range are especially useful in the production of oxide films according to this invention.

The organic polymer may also be a material, which solidifies after the water or solvent is removed by evaporation, such that the resulting dried film is continuous and coherent prior to polymer removal. The polymer may be selected such that the final inorganic oxide film is transparent. The term “transparent” is defined as the property of transmitting light through the film without appreciable scattering so that objects or images can be seen clearly through the film without appreciable distortion. The degree of transparency of the inorganic oxide film may be measured by means of a spectrophotometer in the visible spectrum (e.g., 450-650 nm) with results given in % Transmission or Absorbance.

The polymer typically is either soluble or self-dispersible in water at some point within the pH range of 3 to 10.5. The polymer should be compatible with the silica dispersion in that the mixture does not gel or precipitate. In practice, this compatibility should last for a period of at least one-half hour after mixing.

Typically, the polymer may be hydrophilic. Hydrophilic polymers are often characterized by containing some polar groups in addition to the carboxylic acid groups, which are responsible for their solubility in water. Polar groups, which provide hydrophilic polymers are hydroxyl, amide, methoxy, alkoxyl, hydroxy alkoxy, keto groups, and carboxylic acid ester groups of the lower alcohols, particularly methyl and ethyl.

The polymer may be polyvinyl alcohol, a salt of a carboxylic acid copolymer, a latex emulsionor combinations thereof. Some grades of polyvinyl alcohol are suitable and medium molecular weight (medium viscosity), partially hydrolyzed grades are especially preferred. High molecular weight (high viscosity) polyvinyl alcohol grades may be used but the resulting coating mixtures are often difficult to mix and/or coat because of the high viscosity of the polymer and mixture. Low molecular weight polyvinyl alcohol grades may also be used but the final inorganic oxide films have a greater tendency to crack. Partially hydrolyzed polyvinyl alcohol grades with the degree of hydrolysis ranging from 85-90% are preferred. Coatings made from fully hydrolyzed grades (greater than about 98% hydrolysis) are usually not transparent and tend to crack, although mixtures of partially and fully hydrolyzed grades may give transparent, crack free inorganic oxide coatings.

A carboxylic, polyanionic polymer containing sufficient proportion of carboxyl group that the ammonia salt of the polymer is soluble may also be used.

An example of this type of polymer is an emulsion co-polymer of acrylic acid and methyl acrylate.

In general, polymers having molecular weights less than about 10,000 are often brittle and have poor adhesive strength. On the other hand, polymers having a molecular weight of 50,000 or higher are useful in the present invention.

The proportion of organic polymer in the coating composition may be from about 5 to about 100% by weight, based on the weight of the silica. Typically, the polymer is present in a proportion from about 15 to about 80% by weight based on the weight of silica, and more typically, the polymer is present in a proportion from about 25 to about 70% by weight of the silica. It will be understood that the proportions may be adjusted, within the range specified, to take account of the particular silica being used and the type of coating desired (e.g., film transparency, film electrically insulating properties, film thickness, etc.).

In general, the relative amount of polymer required to prevent crazing of the silica film, depends upon the particle size of the silica. Thus, colloidal silica containing 7 nanometer average diameter particles will require as much as 50% more polymer than 20 nm average diameter particles, the amount of which depends on the thickness and transparency desired in the final silica film.

The total solids content of the coating composition may be up to about 70% by weight, typically may be from about 1% to about 40% by weight, and even more typically from about 5% to about 30% by weight of the coating composition. This maximum concentration is, of course, also limited, depending on the particle size and the type of silica utilized in the coating composition. The maximum concentration of the coating composition is, of course, limited by the maximum concentration attainable for silica and polymer being utilized.

For example, colloidal silica containing particles of 7 nm average diameter have no greater than about 30% silica content while colloidal silica with average particle size greater than 20 nm may have 50-60% silica content. Similarly, aqueous polymer dispersions may range from 2-50% solids.

Another embodiment according the present invention relates to the addition of certain oxidizing agents to the coating composition. Such oxidizing agents may be used to increase the removal rate of the polymer from the coating composition after deposition. Oxidizers may include sodium nitrate, ammonium nitrate, sodium percholorate, or mixtures thereof. The oxidizer may be added as a dilute solution to the coating formulation such that the formulation contains one part by weight of the oxidizer to about 1 to 100,000 parts by weight of the polymer.

Various additives, while not essential, may be used in the coating compositions of this invention. Thus, there may be included defoamers, surfactants, wetting agents, viscosity control agents, and the like, in amounts that yield acceptable film properties and an acceptable level of transparency. Evaporation control agents may also be added to regulate the rate at which volatile constituents are removed from the mixture. Agents, such as hydrazine, thiourea, and commercially available antioxidants and corrosion inhibitors, may also be added to the composition. In general, it is desirable to select agents, which, similar to the polymer, are removable by volatilization or oxidation. When it is desired that the final coatings have good electrical insulation properties, the agents selected preferably will have a low inorganic content. All of the above-mentioned agents are conventional additions to aid in the application of liquids to surfaces for the purpose of forming films thereon and those skilled in the art will have no difficulty selecting particular agents as additives to accomplish these and other purposes.

The above-described coating compositions may be advantageously used for forming adherent films on a wide variety of materials such as glass, metal, paper, wood, plaster, stone, plastics, and the like. However, they are especially effective for forming coatings upon glass.

In the production of the oxide film of this invention, the first step is to prepare the silica polymer composition as already described herein. The substrate surface is suitably prepared, according to conventional methods, as for instance, by solvent cleaning to remove oily dirt, acid pickling to remove rust and corrosion, and alkali cleaning to remove scale or various types of surface contaminants.

The silica polymer composition is then applied to the substrate by any means appropriate to the application that will result in the desired uniform, wet coating of required thickness: knifing, dipping, spraying, rolling, screening, etc.

Subsequently, the coating may be solidified or dried by evaporating off the liquid present in the coating composition. This can readily be done by conventional methods such as air-drying at ordinary temperatures or by drying in a hot-air furnace, induction heating, and the like. The length of time and temperatures utilized in this step may be varied. The coating may also be dried under vacuum. The dried coating is next subjected to a heat treatment that is sufficient to remove the polymer present in the dried film. The specific temperature required to perform such a task will depend upon the polymer, which is utilized in the coating composition. If the polymer is one that may be volatilized readily, one may employ a temperature slightly above the volatilization temperature. On the other hand, if the polymer does not volatilize (i.e., is removed by oxidation), higher temperature may be employed and air or another oxygen-containing gas must be present. In any event the firing temperature utilized must be well below the melting point or decomposition of the substrate being coated. Such firing temperatures may range from about 200 to about 900° C., and typically, from about 200 to about 600° C. Firing time will depend on the temperature used and to some extend on the coating thickness. Optionally, the coating may be dried and fired concurrently, or in a single step.

In one embodiment of this invention, the amount of coating composition applied to a substrate is such that after removal of the polymer, the oxide coating possesses a thickness of more than about 2 microns, and typically, more than about 5 microns, and more typically, more than about 8 microns. Additional layers of the coating composition may be applied to the substrate, and subsequently fired again to give a hard, continuous and transparent oxide film to provide a total multilayer thickness of 5-20 microns or greater. The individual layers may contain particles with different particle sizes or particle distributions to optimize transparency characteristics for a given thickness. In another embodiment of the present invention, the fired film possesses a transparency such that % Transmission in visible wavelengths (450-650 nm) is greater than about 70%, typically greater than 80% and more typically greater than 88%. In another embodiment of the present invention, the fired film possesses an electrical resistance such that the breakdown voltage or dielectric strength of the coating of at least about 20V, and typically, at least about 40V and even more typically, greater than about 100-200V, and even as high as 1000V. The entire subject matter of all patents and publications listed in the present application are incorporated herein by reference.

The following Examples are given as specific illustrations of the claimed invention. It should be understood, however, that the invention is not limited to the specific details set forth in the Examples. All parts and percentages in the Examples, as well as in the remainder of the specification, are by weight unless otherwise specified.

While the invention has been described with a limited number of embodiments, these specific embodiments are not intended to limit the scope of the invention as otherwise described and claimed herein. It may be evident to those of ordinary skill in the art upon review of the exemplary embodiments herein that further modifications and variations are possible. All parts and percentages in the examples, as well as in the remainder of the specification, are by weight unless otherwise specified. Further, any range of numbers recited in the specification or claims, such as that representing a particular set of properties, units of measure, conditions, physical states or percentages, is intended to literally incorporate expressly herein by reference or otherwise, any number falling within such range, including any subset of numbers within any range so recited. For example, whenever a numerical range with a lower limit, R_{L}, and an upper limit R_{U}, is disclosed, any number R falling within the range is specifically disclosed. In particular, the following numbers R within the range are specifically disclosed: R=R_{L}+k(R_{U}−R_{L}), where k is a variable ranging from 1% to 100% with a 1% increment, e.g., k is 1%, 2%, 3%, 4%, 5%. . . . 50%, 51%, 52%. . . . 95%, 96%, 97%, 98%, 99%, or 100%. Moreover, any numerical range represented by any two values of R, as calculated above is also specifically disclosed. Any modifications of the invention, in addition to those shown and described herein, will become apparent to those skilled in the art from the foregoing description and accompanying drawings. Such modifications are intended to fall within the scope of the appended claims.

### Illustrative Examples

Various colloidal silica sols are utilized as the inorganic oxide prepared to demonstrate this invention. All are prepared from sodium silicate by conventional means and are described as follows:

Colloidal Silica A, a sodium hydroxide stabilized sol containing monodisperse particles of 12 nm average diameter is surface modified with sodium aluminate by conventional means, then deionized to remove sodium. The resulting product contained 30% SiO₂ by weight with pH 4.0 and specific surface area of 220 m²/g. The sol contained 0.07% Na by weight, so Silica/Na ratio=429, a ratio that is greater than the value of 141 required by Equation 1.

Colloidal Silica B, a sodium hydroxide stabilized sol containing monodisperse particles of 12 nm average diameter is deionized to remove sodium. It is stabilized with ammonium hydroxide to pH 9.5. The resulting product contained 30% SiO₂, a specific surface area of 220 m²/g and a Silica/Na ratio=430.

Colloidal Silica C, a sodium hydroxide stabilized silica sol containing containing monodisperse particles of 22 nm average diameter is deionized to remove sodium and stabilized with ammonia to pH 9.2. It contained 40% SiO₂, a specific surface area of 140 m²/g and a Silica/Na ratio=540.

Colloidal Silica D, a sodium hydroxide stabilized silica sol is prepared from sodium silicate to yield a polydisperse product containing 50% SiO₂ and with a median particle size of 22 nm, with 80% of the particles between 10 and 50 nm, specific surface area=70 m²/g and silica solids to sodium ratio=179.

Colloidal Silica E, a polydisperse sodium hydroxide stabilized silica sol described in Colloidal Silica D is surface modified with 3-aminopropyltriethoxysilane. To prepare E, two mixtures are made. In the first mixture, colloidal silica sol is acidified with 6N HCI to pH 4. In the second mixture, 317 g deionized water and 250 g 1N HCI are mixed, after which 63.5 g 3-aminopropyltriethoxysilane is slowly added. After adjusting this mixture to pH 4, it is added to the first mixture of acidified colloidal silica, yielding a cationic colloidal silica product containing 40% SiO₂.

Colloidal Silica F, a polydisperse sodium hydroxide stabilized silica sol described in Colloidal Silica D is deionized to remove sodium and stabilized with ammonium hydroxide to pH 9. The resulting product contained 40% SiO₂.

### Example 1

4.4 g of Colloidal Silica A is mixed with 3.6 g of a 15.5% aqueous solution of an 88% hydrolyzed grade of polyvinyl alcohol, as the removable polymer. This solution contained 16.5% SiO₂ and 7% polyvinyl alcohol, giving a polymer/SiO₂ ratio=0.42. This solution is coated with a wire wound coating bar onto a transparent glass sheet and air dried at room temperature. The resulting film is transparent and colorless. It is heated in air in a furnace for 45 minutes at 500° C. In the first few minutes, the film turned a dark brown but cleared over the remaining time. After this heat treatment, the resulting tough, glassy film was 9 microns thick, transparent and colorless, having >90% Transmission in visible wavelengths.

### Example 2

The coating solution of Example 1 is coated on an aluminum metal sheet and air dried at room temperature. Heating for 45 minutes at 500° C. resulted in a tough, glassy film much like that of Example 1. High electrical resistance was measured when one probe of an ohm meter is placed on the coated film and the other probe is placed on the aluminum sheet.

### Example 3

Coating solutions are prepared from each of Colloidal Silica B, C and E and the 15.5% solution of 88% hydrolyzed polyvinyl alcohol in the manner of Example 1. In each coating solution, the mixture contained 16.5% SiO₂ and 7% polyvinyl alcohol. Coatings are formed (as in Example 1) onto transparent glass sheets and air dried at room temperature, then heated for 45 minutes at 500° C. After this heat treatment, the resulting tough, glassy films are obtained that are about 5-9 microns thick. Coatings from Colloidal Silica B, C and E are transparent and colorless, and have >85% Transmission in visible wavelengths, although the coating from Colloidal Silica E was slightly lower. Coatings of B, C and E made on aluminum sheets from these coating solutions are air dried and heated similarly to remove the polymer. The resulting inorganic oxide coatings are clear and exhibited high electrical resistance when one probe of an ohm meter is placed on each coated film and the other probe is placed on the aluminum sheet.

### Example 4

This is an example of a multilayer coating to demonstrate how they may be used to make thicker, transparent films. Equal parts of Colloidal Silica C and Colloidal Silica F are mixed together. To this mixture is added a 15.5% solution of 88% hydrolyzed polyvinyl alcohol. The resulting mixture contained 16.5% SiO₂ and 7% polymer. This is coated onto a glass plate with a wire wound bar and air dried to a dry thickness of 6 microns. A second mixture is prepared with Colloidal Silica C and a 15.5% solution of 88% hydrolyzed polyvinyl alcohol. The resulting mixture also contained 16.5% SiO₂ and 7% polymer. This is coated on top of the first layer with a wire wound bar and air dried at room temperature to a thickness of 8 microns. The coating is then heated for 45 minutes at 500° C. to obtain a crack free coating with 80-85% Transmission.

What is claimed:

1. An inorganic oxide coating produced by,
(a) preparing a coating composition comprising inorganic oxide particles and a polymer,
(b) applying the composition on a substrate to form a coating, and
(c) heating the coating to remove the polymeric component and form said inorganic oxide coating,
wherein said inorganic oxide coating is transparent.

2. An inorganic oxide coating according to claim 1, wherein said coating is dried prior to removing the polymeric component.

3. An inorganic oxide coating according to claim 1 wherein the particles in said coating are non-aggregated.

4. An inorganic oxide coating according to claim 1 wherein said coating is electrically insulating.

5. An inorganic oxide coating according to claim 1 wherein said inorganic oxide comprises silica, alumina, titania, zirconia.

6. An inorganic oxide coating according to claim 1 wherein said inorganic oxide comprises silica.

7. An inorganic oxide coating according to claim 1 wherein said inorganic oxide comprises colloidal silica.

8. An inorganic oxide coating according to claim 1 wherein said inorganic oxide comprises sodium in an amount of less than that defined by the relationship:
SiO₂/Alkali Metal≧AW(−0.013*SSA+9)
wherein the SiO₂/Alkali Metal is the weight ratio of silica solids and alkali metal in the colloidal silica sol; AW is the atomic weight of the alkali metal; and SSA is the specific surface area of the inorganic oxide particles in units of square meters per gram (m²/g).

9. An inorganic oxide coating according to claim 1 wherein said coating possesses a breakdown voltage of at least 20V.

10. An inorganic oxide coating according to claim 1 wherein said coating possesses a breakdown voltage of at least 100V.

11. An inorganic oxide coating according to claim 1 wherein said coating possesses a transparency with % Transmission greater than 70 across visible wavelengths.

12. An inorganic oxide coating according to claim 1 wherein said coating possesses a thickness of 1-20 microns.

13. An inorganic oxide coating according to claim 1 wherein said polymer comprises polyvinyl alcohol, carboxylic acid copolymer salts, latex emulsions or combinations thereof.

14. An inorganic oxide coating according to claim 1 wherein said substrate comprises glass, metal, ceramic and other materials that resist the temperature of polymer removal in step (c).

15. An inorganic oxide coating according to claim 1 wherein said heating is performed at temperatures of about 200° C. to about 900° C.

16. An inorganic oxide coating according to claim 1 wherein said coating comprises multiple layers.

17. An inorganic oxide coating according to claim 1 wherein said applying comprises knifing, dipping, spraying, rolling, screening or any other means that will result in a coating of even distribution and thickness.

18. An inorganic oxide coating according to claim 1 wherein said substrate is a component of a flat panel display device.

19. An inorganic oxide coating according to claim 1, wherein said substrate is a plasma display, liquid crystal display, organic light emitting diode display, digital light processor display or similar display device.

20. An inorganic oxide coating according to claim 1, wherein said coating composition comprises at least one oxidizing agent.

21. An inorganic oxide coating according to claim 20, wherein said at least one oxidizing agent comprises sodium nitrate, sodium percholorate, ammonium nitrate or mixtures thereof.

22. A component of a flat panel display device comprising an inorganic oxide coating produced by,
(a) preparing a coating composition comprising inorganic oxide particles and a polymer,
(b) applying the composition on said display to form a coating, and
(c) heating the substrate to remove the polymeric component and form said inorganic oxide coating,
wherein said inorganic oxide coating is transparent.
